(19) United States
(12) Patent Application Publication
(10) Pub. No.: US 2017/0119029 A1
(43) Pub. Date: May 4, 2017

(54) Method for producing hot pepper paste and hot pepper paste prepared therefrom

(71) Applicant: CJ Cheiljedang Corporation, Seoul (KR)

(72) Inventors: Een Seok Jang, Gyeonggi-do (KR); Sun A Cho, Gyeonggi-do (KR); Byung Cheol Lee, Seoul (KR); Hye Won Shin, Seoul (KR); Seon Mi Oh, Gyeonggi-do (KR); Chan Ik Hwang, Gyeongsangnam-do (KR); Jun Haeng Lee, Daejeon (KR); Byung In Jeong, Jeollabuk-do (KR); Tea Myoung Choi, Daejeon (KR)

(21) Appl. No.: 15/331,022

(22) Filed: Oct. 21, 2016

(30) Foreign Application Priority Data
Oct. 28, 2015 (KR) 10-2015-0150034

(51) Int. Cl. A23L 11/20; A23L 27/24; A23L 27/50; A23L 27/12

(52) U.S. Cl. CPC A23L 11/20; A23L 27/12; A23L 27/24; A23L 27/50; A23V 2002/00

(57) ABSTRACT

A method for producing a hot pepper paste using a mixed koji of soybean and rice, and a hot pepper paste prepared by the production method. More specifically, a method for producing a hot pepper paste that uses ground, cut or pressed soybeans to prepare a hot pepper paste with high production efficiency, and a hot pepper paste with enhanced activity of protease as prepared by the production method.

### CROSS RELATED APPLICATION

This application claims priority to Korean Patent Application Serial No. 10-2015-0150034, filed on Oct. 28, 2015, the contents of which is incorporated herein by reference.

### FIELD OF THE INVENTION

The present invention relates to a method for producing a hot pepper paste using a mixed koji of soybean and rice, and a hot pepper paste prepared therefrom.

More specifically, the present invention relates to a method for producing a hot pepper paste and a hot pepper paste prepared therefrom, which method uses ground, cut and pressed soybeans to prepare a hot pepper paste with high production efficiency and enhanced activity of protease.

### BACKGROUND OF THE INVENTION

Hot pepper paste (gochujang), a Korean traditional favorite food, has been made in every Korean home together with fermented bean paste (doenjang) and soy sauce (ganjang) according to the traditional methods. Ingredients of hot pepper paste include starch flour, soybean koji, namely, fermented soybean powder (mejugaru), salt, red chili powder, water, etc. Specific examples of the starch flour include glutinous rice flour, nonglutinous rice flour, barley flour, wheat flour, etc. If not explained in a scientific manner, the hot pepper paste made from glutinous rice flour is most highly estimated in terms of taste and quality.

The hot pepper paste does provide its unique taste resulting from the harmonious composition of a sweet taste from the sugars produced by hydrolysis of the starch flour, a savory taste called “umami” from the amino acids produced by hydrolysis of the fermented soybean powder, a spicy taste from the red chili powder, and a salty taste from the salt. Such a taste of the hot pepper paste can vary depending on the mixing ratio of the ingredients and the conditions of the aging process.

On the other hand, the production method for hot pepper paste includes the step of processing soybeans into fermented soybeans and adding the fermented soybeans; or soaking normal soybeans, performing a steaming process on the soaked soybeans, mixing the steamed soybeans with whole rice separately soaked in water and steamed, and then fermenting the steamed soybeans and whole rice. However, this method involves water-soaking and steaming soybeans and whole rice separately at different times, resulting in low production efficiency and low protein activity.

To cope with this problem, KR Patent Publication No. 10-2012-0103998 discloses a hot pepper paste containing a lactic acid bacteria using soybean protein and red chili powder as main ingredients, and a preparation method for the same. More specifically, the patent document describes a method for preparing a hot pepper paste and a hot pepper paste made by the preparation method, where the method includes: extracting a protein from soybeans, using it as a culture medium of microorganisms to proliferate a lactic acid bacteria, mixing the soybean protein with red chili powder, and then performing a second aging (fermentation). But, the method involves a separate process of extracting soybean protein and thus leads to low production efficiency.

In an attempt to solve this problem, the inventors of the present invention have developed a novel method for producing a hot pepper paste and a hot pepper paste produced by the method, which method uses ground, cut or pressed soybeans to prepare a hot pepper paste with high production efficiency and enhanced activities of amylase and protease, thereby completing the present invention.

### CITED DOCUMENT

### Patent Document

Patent Document 0001: KR Patent Publication No. 10-2012-0103998

### BRIEF SUMMARY OF THE INVENTION

It is therefore an object of the present invention to provide a method for producing a hot pepper paste and a hot pepper paste produced by the method, which method uses ground, cut or pressed soybeans to prepare a hot pepper paste with high production efficiency and enhanced activities of amylase and protease.

For achieving the object of the present invention, there is provided a method for producing a hot pepper paste that includes: a soaking step of adding water to ground, cut or pressed soybean and whole rice to soak the ground, cut or pressed soybean and the whole rice in water; a steaming step of steaming the ground, cut or pressed soybean and the whole rice from the soaking step with a saturated steam; a koji-making step of inoculating the ground, cut or pressed soybean and the whole rice from the steaming step with a strain and culturing the strain to make a koji; a first aging step of performing a first aging on the koji from the koji-making step; and a second aging step of mixing the koji from the first aging step with at least one selected from the group consisting of red chili powder, starch sugar, soy sauce, salt, processed spice, sweetener, and processed grain and then adding an edible alcohol to the mixture to perform a second aging.

According to the present invention, there is also provided a hot red pepper prepared by the production method.

### EFFECTS OF INVENTION

The present invention can provide a method for producing a hot pepper paste that uses ground, cut or pressed soybeans to prepare a hot pepper paste with high production efficiency, and a hot pepper paste with enhanced activity of protease as prepared according to the production method.

### BRIEF DESCRIPTION OF THE SEVERAL VIEW OF THE DRAWING

FIG. 1 is a flow chart showing a method for producing a hot pepper paste according to the present invention.

FIG. 2 is a dendrogram of CJ1354 used in the present invention.

### DETAILED DESCRIPTION OF THE INVENTION

Hereinafter, the present invention will be described in further detail with reference to the accompanying drawings.

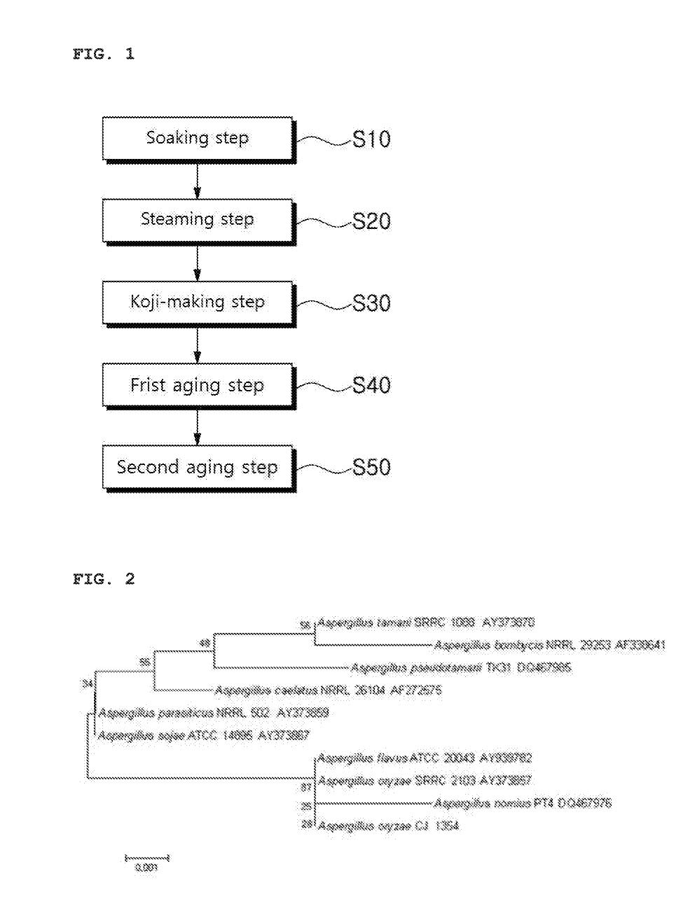

In a first embodiment of the present invention, there is provided a method for producing a hot pepper paste that includes: a soaking step S10 of adding water to ground, cut or pressed soybean and whole rice to soak the ground, cut or pressed soybean and the whole rice in water; a steaming step S20 of steaming the ground, cut or pressed soybean and the whole rice from the soaking step with a saturated steam; a koji-making step S30 of inoculating the ground, cut or pressed soybean and the whole rice from the steaming step with a strain and culturing the strain to make a koji; a first aging step S40 of performing a first aging on the koji from the koji-making step; and a second aging step S50 of mixing the koji from the first aging step with at least one selected from the group consisting of red chili powder, starch sugar, soy sauce, salt, processed spice, sweetener, and processed grain, and then adding an edible alcohol to the mixture to perform a second aging (Refer to FIG. 1).

In the present invention, the soaking step S10 is a process of adding water to ground, cut or pressed soybean and whole rice to soak the ground, cut or pressed soybean and the whole rice in water. Grinding means breaking soybeans to fine particles. Cutting is cutting or clipping soybeans. Pressing is crushing soybeans to flat or crack. The ground, cut or pressed soybeans may be prepared by, if not limited to, grinding, cutting or pressing soybeans with a grinding machine, a cutter or press rollers. The method may further include a step of sorting and washing soybeans prior to the soaking step S10.

More specifically, the soaking step S10 is adding water to the ground, cut or pressed soybean and the whole rice and soaking the ground, cut or pressed soybean and the whole rice in water for a predetermined period of time. The ground, cut or pressed soybean and the whole rice may be soaked at the same time. The conventional production method using normal soybeans (hereinafter, referred to as “round soybeans”) takes much time to reach a desired water content due to low water absorption of round soybeans and thus requires a separate step for soaking and processing the round soybeans apart from the whole rice. In contrast, the method of the present invention, using ground, cut or pressed soybeans, takes a relatively short time to reach a desired water content and thus allows the soybeans and the whole rice soaked in water at the same time.

Specifically, the soaking step S10 involves adding 50 to 100 wt. % of purified water with respect to the total weight of the ground, cut or pressed soybean and the whole rice and soaking the ground, cut or pressed soybean and the whole rice in the purified water for 30 to 70 minutes. More specifically, 60 to 90 wt. % of purified water with respect to the total weight of the ground, cut or pressed soybean and the whole rice may be added to soak the ground, cut or pressed soybean and the whole rice for 40 to 60 minutes. When the added amount of water is out of the defined range, the ground, cut or pressed soybean and the whole rice cannot be soaked enough to a desired water content, ending up producing a hot pepper paste with poor quality. In an alternative way, the ground, cut or pressed soybean and the whole rice may be soaked in water under agitation in order to shorten the soaking time and enhance the production efficiency. In this case, the soaking process may be carried out with 30 to 45 wt. % of purified water under agitation for 10 to 20 minutes.

In the present invention, the steaming step S20 is a process of steaming the ground, cut or pressed soybean and the whole rice from the soaking step with a saturated steam. Specifically, the steaming step may be performed to steam the ground, cut or pressed soybean and the whole rice from the soaking step with a saturated steam at the same time. Specifically, the steaming step may include discharging the soaking water at high pressure and feeding a high pressure steam to discharge a condensate and an extra soaking water. More specifically, the high pressure steam, which has a pressure of 1.5 kgf/cm² to 2.5 kgf/cm², may be supplied for 20 to 40 minutes to discharge a condensate and an extra soaking water.

Subsequently, a saturated steam of 0.5 kgf/cm² to 1.5 kgf/cm² is provided for steaming at 60 to 100° C. for 20 to 40 minutes. More specifically, a saturated steam of 0.8 kgf/cm² to 1.2 kgf/cm² may be used for steaming at 70 to 90° C. for 25 to 35 minutes. In the steaming step S20, the pressure and temperature of the saturated steam and the steaming time may vary depending on the water content of the ground, cut or pressed soybean and the whole rice from the soaking step. But, the steam of the defined pressure range can secure a desired water content proper to the after-mentioned koji-making step. Alternatively, when the ground, cut or pressed soybean is soaked in water optionally under agitation, the steaming step S20 may include feeding a saturated steam of 0.5 kgf/cm² to 1.5 kgf/cm² for steaming at 100 to 120° C. for 10 to 20 minutes.

After the steaming step S20, the water content may reach 35 to 50 wt. % for the ground, cut or pressed soybean and 30 to 35 wt. % for the whole rice. These ranges define the water contents optimal to the production of a hot pepper paste and proper to the after-mentioned koji-making step. In particular, the present invention can secure a desired water content within the defined range even though the ground, cut or pressed soybean and the whole rice are steamed at once in a short time.

In the present invention, the koji-making step S30 includes a process of inoculating the ground, cut or pressed soybean and the whole rice from the steaming step with a strain and culturing the strain to make a koji. More specifically, the ground, cut or pressed soybean and the whole rice from the steaming step are cooled down while transferred to a koji-making chamber, and then inoculated with a strain to make a koji. Prior to the koji-making step, a saturated steam may be supplied in order to compensate for the water boiled off from the outer surface and inside of the ground, cut or pressed soybean and the whole rice that are cooled down. More specifically, the saturated steam may be in the pressure range of 0.5 kgf/cm² to 1.5 kgf/cm² and supplied at intervals of 30 to 90 minutes.

The koji-making step S30 may include inoculating the ground, cut or pressed soybean and whole rice with 0.1 to 0.5 wt. % of Aspergillus oryzae used as a koji mould. More specifically, Aspergillus oryzae CJ 1354, belonging to the dendrogram of FIG. 2 and displaying high carbohydrase and protease activities, may be introduced as a koji mould.

The koji-making step S30 may include introducing the strain and performing a fermentation at 33 to 40° C., more specifically at 35 to 40° C. for 3 to 5 days to make a koji. Even though the defined temperature range possibly allows propagation of other bacteria in addition to the koji mould, it is also possible to prepare a koji containing the koji mould as a dominant strain by regulating the water content in the steaming step.

In the present invention, the first aging step S40 may include a process of aging the koji from the koji-making step. Specifically, the first aging step may include adding 10 to 30 wt. % of a saline water at 20 to 40° C. with respect to the weight of the koji. More specifically, the first aging step may include adding 15 to 25 wt. % of a saline water at 30° C. with respect to the weight of the koji. The first aging step S40 may further include adding another 5 to 15 wt. % of steamed whole rice to the koji.

In the first aging step S40, the water content may be controlled to 40 to 50 wt. % by adding a saline water and steamed whole rice. Further, the first aging step S40 may include performing an aging at 25 to 35° C. for 10 to 50 days. More specifically, the first aging step S40 may include performing an aging at 27 to 33° C. for 15 to 45 days. In comparison to the conventional production method for hot pepper paste using round soybeans, the first aging step of the present invention requires less aging time and offers higher activity of protease even in a same aging time, because the ground, cut or pressed soybean has a larger surface area.

In the present invention, the second aging step S50 may include a process of mixing the koji from the first aging step with at least one selected from the group consisting of red chili powder, starch sugar, soy sauce, salt, processed spice, sweetener, and processed grain, and then adding an edible alcohol to the mixture. The method may further include a step of performing sterilization at 55 to 85° C. for 1 to 60 minutes prior to adding the edible alcohol.

More specifically, the second aging step S50 may include adding 6 to 25 wt. % of red chili powder; and 15 to 40 wt. % of at least one selected from the group consisting of red chili powder, starch sugar, soy sauce, salt, processed spice, sweetener, and processed grain. There is no specific limitation to such ingredients as starch sugar, soy sauce, salt, processed spice, sweetener, and processed grain, but known ingredients are available. For example, the processed spice as used herein may include, if is not limited to, dry or wet seasoned spicy sauce, or the like; and the sweetener as used herein may include, but is not limited to, yeast extract, soybean protein extract, wheat protein extract, or the like.

In a second embodiment of the present invention, there is provided a hot pepper paste prepared by the production method of the present invention.

Compared to the conventional hot pepper paste, the hot pepper paste prepared by the production method of the present invention displays high activities of amylase and protease and fits for a mass production.

Hereinafter, the present invention will be described in further detail through the following examples, which are given only for the understanding of the present invention and not construed to limit the scope of the present invention.

### EXAMPLES

### (1) Preparation of Ground, Cut or Pressed Soybean

The shear force between two horizontal rollers of different speeds is used for grinding, cutting and/or pressing soybeans to prepare ground, cut or pressed soybeans.

### Example 1: Water Content of Ground, Cut or Pressed Soybean as a Function of Soaking Time

This example is to calculate the water absorption of the ground, cut or pressed soybean in comparison to the round soybean and to determine whether the ground, cut or pressed soybean can be processed together with whole rice at the same time in the production of a hot pepper paste. For this, the ground, cut or pressed soybean is soaked with purified water and then measured in regards to the water content as a function of the soaking time. The measurement results are presented in Table 1.

### Example 2: Water Content of Whole Rice as a Function of Soaking Time

The whole rice is soaked with purified water and then measured in regards to the water content as a function of the soaking time. The measurement results are presented in Table 1.

### Comparative Example 1: Water Content of Round Soybean by Soaking Time

In the same manner as described in Examples 1 and 2, the round soybean is soaked with purified water and measured in regards to the water content as a function of the soaking time. The measurement results are presented in Table 1.

TABLE 1
Water content (%) as a function of soaking time

| Div. | 20 min | 30 min | 40 min | 50 min |
|---|---|---|---|---|
| Example 1 | 25.6 | 31.2 | 37.9 | 41.9 |
| Example 2 | 18.5 | 25.5 | 28.4 | 33.4 |
| Comparative Example 1 | 15.3 | 18.9 | 23.8 | 28.8 |

It can be seen that the ground, cut or pressed soybean takes less time to reach a desired water content than the round soybean, thereby reducing the soaking time and enhancing the production efficiency. Further, the ground, cut or pressed soybean and the whole rice nearly make no difference in time required to reach a desired water content. This shows that the ground, cut or pressed soybean and the whole rice can be soaked in water at the same time, ending up reducing the grain distribution deviation in the fermented product.

Contrarily, the round soybean, taking more time to reach a desired water content than the whole rice, can not be soaked at the same time with the whole rice.

(2) Soaking and Steaming

This step is to soak and steam the ground, cut or pressed soybean and the whole rice and to obtain a uniform mixture of soybean and rice for reducing the quality deviation. The ground, cut or pressed soybean and the whole rice are steamed with high pressure steam as described in Example 3. Then, the measurement is performed in regards to the hardness. The same procedures are performed with the round soybean in Comparative Example 2.

### Example 3: Water Content and Properties of Ground, Cut or Pressed Soybean after Soaking and Steaming

This example is to measure the water content of the ground, cut or pressed soybean in comparison to the round soybean after soaking and steaming and to determine whether the ground, cut or pressed soybean and the whole rice can be processed at the same time in the production of a hot pepper paste. For this, 75 wt. % of purified water with respect to the total weight of the ground, cut or pressed soybean and the whole rice is put into a steaming machine and used to soak the ground, cut or pressed soybean and the whole rice for 50 minutes. After the soaking process, the soaking water is discharged at high pressure. Then, a high pressure steam (2.0 kgf/cm²) is supplied to discharge a condensate and an extra soaking water for 30 minutes. Subsequently, a saturated steam (1.0 kgf/cm²) is fed to steam the ground, cut or pressed soybean and the whole rice at 80° C. for minutes. The ground, cut or pressed soybean and the whole rice are cooled down to 35° C. The properties of the ground, cut or pressed soybean and the whole rice after steaming are presented in Table 2.

### Comparative Example 2: Water Content and Properties of Round Soybean and Whole Rice after Soaking and Steaming

75 wt. % of purified water with respect to the total weight of the round soybean and the whole rice is put into a steaming machine and used to soak the round soybean and the whole rice for 50 minutes. After the soaking process, the soaking water is discharged at high pressure. Then, a high pressure steam (2.0 kgf/cm²) is supplied to discharge a condensate and an extra soaking water for 30 minutes. Subsequently, a saturated steam (1.0 kgf/cm²) is fed to steam the round soybean and the whole rice at 80° C. for 30 minutes. The round soybean and the whole rice are cooled down to 35° C. The properties of the round soybean and the whole rice after steaming are presented in Table 2.

TABLE 2
Properties of soybean and whole rice as a function of
grinding, cutting or pressing

| | | Desired | Water content | |
|---|---|---|---|---|
| | | water | (%) after | |
| | | content (%) | steaming | Hardness |
| Example 3 | Ground, cut | 48 | 48 | 13 |
| | or pressed | | | |
| | soybean | | | |
| | Whole rice | 33 | 33 | 12 |
| Comparative | Ground, cut | 48 | 34 | 21 |
| Example 2 | or pressed | | | |
| | soybean | | | |
| | Whole rice | 33 | 31 | 12 |

In Table 2, the quality of being hard in texture is presented in terms of relative values. The term “hardness” as used herein refers to a measure of how hard the grains are. To measure the hardness of grains, the grains are steamed, sealed in a container with a wrap, cooled down at the room temperature for 30 to 60 minutes, and mixed well. Then 10 g of the grains are put on a dedicated dish for a texture analyzer (Takemoto, Japan), leveled with a dedicated press machine, and measured in regards to the properties with a dedicated program for the texture analyzer repeatedly ten times. The average of the measurements without maximum and minimum values is calculated as the hardness.

Referring to Table 2, Example 3 has the ground, cut or pressed soybean and the whole rice evenly soaked with water and thus displays no quality deviation, whereas Comparative Example 2 shows deterioration in quality due to the round soybean under-steamed and the whole rice containing too much water.

Further, the ground, cut or pressed soybean of Example 3 has lower hardness than the round soybean of Comparative Example 2. This is because, unlike the ground, cut or pressed soybean, the round bean is underdone when steamed together with the whole rice. It is therefore concluded that the round soybean cannot be steamed together with the whole rice at the same time.

(3) Koji-Making Step

Aspergillus oryzae CJ 1354, a strain with high carbohydrase and protease activities, is introduced into a mixture of the ground, cut or pressed soybean and the whole rice steamed in Example 3 or a mixture of the round soybean and the whole rice steamed in Comparative Example 2, and then cultured to prepare a rice koji as described in Example 4 and Comparative Example 3. Each mixed koji of soybean and rice is then evaluated in regards to enzyme activities.

### Example 4: Enzyme Activities of Aspergillus oryzae CJ 1354 in Mixed Koji of Ground, Cut or Pressed Soybean and Whole Rice

In order to determine the amylase and protease activities in a koji made from the ground, cut or pressed soybean in comparison to the round soybean, the ground, cut or pressed soybean and the whole rice as steamed in Example 3 are cooled down while transferred to a koji-making chamber, and then supplied with a saturated steam (1.0 kgf/cm²) every one hour to compensate for the water boiled off from their outer surface and inside. Subsequently, the ground, cut or pressed soybean and the whole rice are inoculated with 0.2 wt. % of novel Aspergillus oryzae CJ 1354 and then subjected to a koji fermentation process at 38° C. for 3 days. The enzyme activities of the mixed koji made from the ground, cut or pressed soybean and the whole rice are presented in Table 3.

### Comparative Example 3: Enzyme Activities of Aspergillus Oryzae CJ 1354 in Mixed Koji of Round Soybean and Whole Rice

The round soybean and the whole rice as steamed in Comparative Example 2 are cooled down while transferred to a koji-making chamber, and then supplied with a saturated steam (1.0 kgf/cm²) every one hour to compensate for the water boiled off from their outer surface and inside. Subsequently, the round soybean and the whole rice are inoculated with 0.2 wt. % of novel Aspergillus oryzae CJ 1354 and then subjected to a koji fermentation process at 38° C. for 3 days. The enzyme activities of the mixed koji made from the round soybean and the whole rice are presented in Table 3.

TABLE 3
Enzyme activities of Aspergillus oryzae CJ 1354 in mixed
koji of soybean and whole rice as a function of grinding,
cutting or pressing

| | Amylase activity | Protease activity |
|---|---|---|
| Div. | (U/g) | (U/g) |
| Example 4 | 464 | 100 |
| Comparative Example 3 | 460 | 73 |

As can be seen from Table 3, the koji of Example 4 has the higher protease activity than the koji of Comparative Example 3 by 37%.

(4) First Aging Step

Each koji of Example 4 and Comparative Example 3 is used to prepared a first mixture as described in the following Example 5 and Comparative Example 4 and then aged at 30° C. for 15 to 30 days. The first mixture is measured in regards to the water content and the amino-nitrogen content (mg %) as a function of the aging time to evaluate the degree of aging.

### Example 5: Enzyme Activity of First Mixture Made from Koji of Example 4 as a Function of Aging Time

This example is to measure the amino-nitrogen content (mg %) as a function of the aging time of the first aging step and to evaluate the degree of aging. For this, 15 wt. % to 25 wt. % of saline water at 30° C. with respect to the total weight of the mixed koji of ground, cut or pressed soybean and whole rice as prepared in Example 4 is added to the mixed koji. Then, 5 to 15 wt. % of steamed whole rice is further added to prepare a first mixture having the final water content of 45 wt. %. The amino-nitrogen content as a function of the aging time is presented in Table 4.

### Comparative Example 4: Enzyme Activity of First Mixture Made from Koji of Comparative Example 3 as a Function of Aging Time

15 wt. % to 25 wt. % of saline water at 30° C. with respect to the total weight of the mixed koji of round soybean and whole rice as prepared in Comparative Example 3 is added to the mixed koji. Then, 5 to 15 wt. % of steamed whole rice is further added to prepare a first mixture having the final water content of 45 wt. %. The amino-nitrogen content as a function of the aging time is presented in Table 4.

TABLE 4
Amino-nitrogen content (mg %) by first aging time of mixed
koji made from soybean and whole rice as a function of grinding,
cutting or pressing

| | 5-day | 10-day | 20-day | 30-day |
|---|---|---|---|---|
| | aging | aging | aging | aging |
| Example 5 | 64 | 89 | 114 | 130 |
| Comparative Example 4 | 62 | 78 | 89 | 101 |

Generally, the aging completion time of the first mixture is considered as the time when the amino-nitrogen content (mg %) becomes 100 or above. In comparing Example 5 and Comparative Example 4, the first mixture (Example 5) made from the koji of Example 4 has an amino-nitrogen content of 100 or greater in 20 days of aging, while the first mixture (Comparative Example 4) made from the koji of Comparative Example 3 has an amino-nitrogen content of 100 or greater in 30 days of aging. In conclusion, the koji using the ground, cut or pressed soybean and the whole rice is 1.5 time faster in aging than the koji using the round soybean and the whole rice.

(5) Second Aging Step and Preparation of Hot Pepper Paste

Red chili powder is added to the aged first mixture, and at least one selected from the group consisting of starch sugar, soy sauce, salt, processed spice, sweetener, and processed gain is added to the first mixture to prepare a second mixture. The second mixture thus obtained is sterilized at 55 to 85° C. for 1 to 60 minutes and, with an addition of an edible alcohol, subjected to aging.

### EXPLANATION OF REFERENCE NUMERALS

S10: Soaking step
S20: Steaming step
S30: Koji-making step
S40: First aging step
S50: Second aging step

### Accession Number

Depositor organization: Korean Culture Center of Microorganisms (international)
Accession number: KCCM11300P
Accession date: 09/27/2012

What is claimed is:

1. A method for producing a hot pepper paste, comprising:
(1) adding water to ground, cut or pressed soybean and whole rice to soak the ground, cut or pressed soybean and the whole rice in water;
(2) steaming the ground, cut or pressed soybean and the whole rice from the soaking step with a saturated steam;
(3) inoculating the ground, cut or pressed soybean and the whole rice from the steaming step with a strain and culturing the strain to make a koji;
(4) performing a first aging on the koji from the koji-making step; and
(5) mixing the koji from the first aging step with at least one selected from the group consisting of red chili powder, starch sugar, soy sauce, salt, processed spice, sweetener, and processed grain and then adding an edible alcohol to the mixture to perform a second aging.

2. The method as claimed in claim 1, wherein the soaking step comprises soaking the ground, cut or pressed soybean and the whole rice in water at the same time.

3. The method as claimed in claim 1, wherein the soaking step comprises adding 50 to 100 wt. % of purified water with respect to the total weight of the ground, cut or pressed soybean and the whole rice and soaking the soybean and the whole rice in the purified water for 30 to 70 minutes.

4. The method as claimed in claim 1, wherein the soaking step comprises adding 30 to 45 wt. % of purified water with respect to the total weight of the ground, cut or pressed soybean and the whole rice and soaking the soybean and the whole rice in the purified water for 10 to 20 minutes under agitation.

5. The method as claimed in claim 1, wherein the steaming step comprises steaming the ground, cut or pressed soybean and the whole rice from the soaking step at the same time.

6. The method as claimed in claim 1, wherein the saturated steam of the steaming step is 0.5 kgf/cm² to 1.5 kgf/cm² in pressure and used for steaming at 60 to 100° C. for 20 to 40 minutes.

7. The method as claimed in claim 6, wherein the steaming step comprises feeding a high pressure steam of 1.5 kgf/cm² to 2.5 kgf/cm² for 20 to 40 minutes beforehand.

8. The method as claimed in claim 5, wherein the saturated steam of the steaming step is 0.5 kgf/cm² to 1.5 kgf/cm² in pressure and used for steaming at 100 to 120° C. for 10 to 20 minutes.

9. The method as claimed in claim 1, wherein the steaming step comprises steaming the ground, cut or pressed soybean and the whole rice to secure a water content of 35 to 50 wt. % for the ground, cut or pressed soybean and a water content of 30 to 35 wt. % for the whole rice.

10. The method as claimed in claim 1, wherein the second aging step further comprises sterilizing the mixture at 55 to 85° C. for 1 to 60 minutes.

11. A hot pepper paste produced by:
(1) adding water to ground, cut or pressed soybean and whole rice to soak the ground, cut or pressed soybean and the whole rice in water;
(2) steaming the ground, cut or pressed soybean and the whole rice from the soaking step with a saturated steam;
(3) inoculating the ground, cut or pressed soybean and the whole rice from the steaming step with a strain and culturing the strain to make a koji;
(4) performing a first aging on the koji from the koji-making step; and
(5) mixing the koji from the first aging step with at least one selected from the group consisting of red chili powder, starch sugar, soy sauce, salt, processed spice, sweetener, and processed grain and then adding an edible alcohol to the mixture to perform a second aging.

12. The hot pepper paste of claim 11 wherein the soaking step comprises soaking the ground, cut or pressed soybean and the whole rice in water at the same time.

13. The hot pepper paste of claim 11, wherein the soaking step comprises adding 50 to 100 wt. % of purified water with respect to the total weight of the ground, cut or pressed soybean and the whole rice and soaking the soybean and the whole rice in the purified water for 30 to 70 minutes.

14. The hot pepper paste of claim 11, wherein the soaking step comprises adding 30 to 45 wt. % of purified water with respect to the total weight of the ground, cut or pressed soybean and the whole rice and soaking the soybean and the whole rice in the purified water for 10 to 20 minutes under agitation.

15. The hot pepper paste of claim 11, wherein the steaming step comprises steaming the ground, cut or pressed soybean and the whole rice from the soaking step at the same time.

16. The hot pepper paste of claim 11, wherein the saturated steam of the steaming step is 0.5 kgf/cm² to 1.5 kgf/cm² in pressure and used for steaming at 60 to 100° C. for 20 to 40 minutes.

17. The hot pepper paste of claim 16, wherein the steaming step comprises feeding a high pressure steam of 1.5 kgf/cm² to 2.5 kgf/cm² for 20 to 40 minutes beforehand.

18. The hot pepper paste of claim 15, wherein the saturated steam of the steaming step is 0.5 kgf/cm² to 1.5 kgf/cm² in pressure and used for steaming at 100 to 120° C. for 10 to 20 minutes.

19. The hot pepper paste of claim 11, wherein the steaming step comprises steaming the ground, cut or pressed soybean and the whole rice to secure a water content of 35 to 50 wt. % for the ground, cut or pressed soybean and a water content of 30 to 35 wt. % for the whole rice.

20. The hot pepper paste of claim 11, wherein the second aging step further comprises sterilizing the mixture at 55 to 85° C. for 1 to 60 minutes.
